(19) United States
(12) Patent Application Publication
(10) Pub. No.: US 2021/0323185 A1
(43) Pub. Date: Oct. 21, 2021

(54) CUTTING DEVICE AND METHOD FOR CUTTING PAPER

(71) Applicant: SDD HOLDING B.V., Emst (NL)

(72) Inventor: Johannes Franciscus Roland OUDSEN, Emst (NL)

(21) Appl. No.: 17/270,948

(22) PCT Filed: Aug. 16, 2019
(86) PCT No.: PCT/NL2019/050534

§ 371 Date: Feb. 24, 2021

(30) Foreign Application Priority Data
Aug. 30, 2018 (NL) 2021520

(51) Int. Cl. B26D 1/08; B26D 1/00; B26D 5/08

(52) U.S. Cl. CPC B26D 1/085; B26D 2001/0053; B26D 5/086; B26D 1/0006

(57) ABSTRACT

The invention relates to a cutting device and a method for cutting paper, wherein the cutting device comprises a cutting blade and a counter-member that cooperate to cut the paper along a cutting line, wherein the cutting blade is movable towards and away from the counter-member in a driving direction transverse or perpendicular to the cutting line, wherein the cutting device is provided with a drive mechanism to drive the movement of the cutting blade with respect to the counter-member in the driving direction, wherein the drive mechanism comprises a first spindle and a second spindle, wherein the drive mechanism further comprises one or more motors and a mechanical synchronization element in the form of a chain or a toothed belt that is arranged to synchronize the first spindle and the second spindle in a 1:1 ratio.

### BACKGROUND

The invention relates to a cutting device and a method for cutting paper.

DE 299 03 155 U1 discloses a known sheet cutter for cutting paper or cardboard sheets. The sheet cutter is provided with a cutting blade, two mutually parallel spindles that drive the cutting movement of the blade and two electrically controlled, electromagnetic actuators for individually driving each of the spindles. The advantage of this arrangement is that the cutting becomes faster and its timing is more accurate compared to pneumatic solutions.

CN 105 437 284 A discloses an automatic plywood cutting machine with a cutter which is driven at both sides by a screw. The screws are driven by two umbrella gears. The umbrella gears are driven by a drive shaft that is driven by a chain connected to a motor.

US 2009/165,625 A1 and US 2015/020662 A1 disclose sheet cutting devices, each provided with a cutter that is eccentrically driven by two rotation members.

### SUMMARY OF THE INVENTION

The known sheet cutter of DE 299 03 155 U1 is used to cut through a continuous sheet of paper or cardboard. No counter-blade is used. The loads in such a sheet cutter are relatively small. When applying the teaching of DE 299 03 155 U1 to heavy duty cutters, i.e. cutters for cutting through stacks of paper or booklets, the known spindle driven cutting blade has the disadvantage that the cutting blade may experience uneven loads during the cutting stroke, for example when cutting through the spine of a booklet or when a stack of paper sheets is offset to one side of the cutting blade. More in particular, when applying the teaching to guillotine cutters with angled cutting blades, it will be appreciated that the heavy loads travel along the cutting blade as the angled cutting blade cuts through the paper. In each of the aforementioned situations, uneven loads exerted on the cutting blade may cause one spindle to be driven faster than the other, which can result in misalignment, poor cutting quality and ultimately malfunction of the cutting device.

The transmission in the plywood cutting machine of CN 105 437 284 A has a lot of mechanical parts (motor, chain, drive shaft, four umbrella gear wheels, two screws) which all have to be carefully fitted and aligned to work properly. Moreover, at each transmission (motor to drive shaft, drive shaft to umbrella gear, umbrella gear to screw), tolerances may occur that are critical to the synchronization between the screws and ultimately the cutting quality.

It is an object of the present invention to provide a cutting device and a method for cutting paper in which the positioning of the cutting blade can be improved.

According to a first aspect, the invention provides a cutting device for cutting paper, wherein the cutting device comprises a cutting blade and a counter-member that cooperate to cut the paper along a cutting line, wherein the cutting blade is movable towards and away from the counter-member in a driving direction, transverse or perpendicular to the cutting line, for cutting the paper, wherein the cutting device is provided with a drive mechanism to drive the movement of the cutting blade with respect to the counter-member in the driving direction, wherein the drive mechanism comprises a first spindle and a second spindle which are arranged to act on the cutting blade in or parallel to the driving direction, wherein the drive mechanism further comprises one or more motors for driving the first spindle and the second spindle and a mechanical synchronization element in the form of a chain or a toothed belt that is arranged to synchronize the first spindle and the second spindle in a 1:1 ratio.

The mechanical synchronization element can effectively prevent that one of the spindles runs faster than the other. In particular, the mechanical synchronization element can ensure that both spindles run at a 1:1 ratio. Hence, the driving force can be distributed uniformly over the cutting blade to ensure that it remains properly aligned with the driving direction, regardless of any uneven or varying loads on said cutting blade. By mechanically synchronizing the spindles, more expensive and possibly less effective solutions such as reinforcing the cutting device as a whole, increasing the size of the actuators or electronically controlling the actuators, can be avoided.

The spindles can effectively convert rotation into a linear motion in the driving direction. In particular, small pitched spindles can be driven by one or more relatively small motors and still deliver a relatively high driving force to the cutting blade.

The chain and the toothed belt are both characterized by links or teeth arranged in a repetitive pattern with equal intervals. Hence, the chain or toothed belt can be reliably engaged by suitable driving elements, such as gears or sprocket wheels. The uniform interval between the links or the teeth can further reduce slipping or accumulation of tolerances. Moreover, a chain or a toothed belt can be relatively durable, considering that the cutting device will have to make hundreds of thousands of cuts. Finally, the chain or toothed belt can be easily installed and/or mounted without requiring further alignment.

In particular, the length of the chain or toothed belt may be chosen such that it engages tightly around the driving elements, in particular around gears or sprocket wheels. Alternatively, a chain or toothed belt tensioner may be provided to generate tension in the chain or toothed belt after it has been installed and/or mounted. The tensioner may for example be biased to move into a tensioning position by a spring.

In a further embodiment thereof the drive mechanism comprises an idler wheel at each of the spindles, wherein the synchronization element interconnects the idler wheel at the first spindle with the idler wheel at the second spindle in a 1:1 ratio. Hence, the spindles can be directly interconnected by the synchronization element, thereby mechanically synchronizing their respective drive speeds.

In one particular embodiment the one or more motors comprises a single motor that drives the movement of both the first spindle and the second spindle in the driving direction. Using a single motor to drive both spindles can significantly reduce the cost of the driving mechanism. Moreover, the synchronization element can ensure that the driving force from the single motor is uniformly distributed to both spindles.

In an embodiment thereof the drive mechanism comprises a main sprocket wheel that is directly connected to the single motor and that drives the synchronization element, wherein the drive mechanism comprises an idler wheel at each of the spindles, wherein the synchronization element connects the main sprocket wheel to the idler wheel at the first spindle and the idler wheel at the second spindle. The synchronization element may be arranged in a loop around the main sprocket wheel and both idler wheels.

Preferably, the main sprocket wheel and the idler wheels at the spindles are rotatable about wheel axes parallel or substantially parallel to the driving direction. Hence, the transmission of the rotation of the main sprocket wheel to the idlers wheels can all occur in the same plane.

In a further embodiment thereof the main sprocket wheel is connected to the idler wheels in a ratio of at least 2:1, preferably at least 2.5:1 and most preferably at least 3:1. By having a relatively large ratio, the output speed of the idler wheels can be increased.

In a further embodiment thereof the synchronization element connects the idler wheel at the first spindle to the idler wheel at the second spindle in a ratio of 1:1. Hence, the spindles can be directly interconnected by the synchronization element, thereby mechanically synchronizing their respective drive speeds.

In an alternative embodiment the one or more motors comprises a first motor and a second motor for driving the movement of the first spindle and the second spindle, respectively, in the driving direction. Consequently, more torque can be applied to each spindle as the driving force does not have to be divided. Alternatively, smaller motors can be used with the same result as a single larger motor.

In an embodiment thereof the first motor and the second motor are arranged for directly driving the first spindle and the second spindle, respectively. By driving the spindles directly, the number of moving parts can be reduced.

In a further embodiment thereof the drive mechanism comprises an idler wheel at each of the spindles, wherein the synchronization element interconnects the idler wheel at the first spindle with the idler wheel at the second spindle in a 1:1 ratio. Hence, the spindles can be directly interconnected by the synchronization element, thereby mechanically synchronizing their respective drive speeds.

In another particular embodiment the driving direction is perpendicular to the cutting line. Additionally or alternatively, the cutting blade comprises a flat or substantially flat cutting surface, wherein the driving direction is parallel or substantially parallel to said flat cutting surface. This is characteristic for a guillotine type cutting device.

In an embodiment thereof the cutting blade comprises an upper cutting edge that is angled at an oblique angle to the cutting line. The oblique angle of the cutting edge results in varying loads or a load travelling along the cutting blade as the cutting blade cuts through the paper. In this context, it is very important to keep the cutting blade aligned in the driving direction, in accordance with any one of the aforementioned embodiments.

In an alternative embodiment the driving direction is arranged at an oblique angle to the cutting line. Preferably, the angle is in the range of thirty to eighty degrees and preferably in a range of forty to sixty degrees. At this oblique angle, the cutting blade can make a saw-like movement through the paper, rather than a guillotine cut. As a result, the cutting blade is able to cut through thicker stacks of paper.

In a further embodiment thereof the cutting blade comprises an upper cutting edge that is parallel or substantially parallel to the cutting line. Said cutting edge can make a saw-like movement across the entire cutting line simultaneously.

In another embodiment the one or more motors comprises one or more electro-motors, preferably one or more electric servo-motors. An electro-motor, unlike a pneumatic drive, can be controlled more accurately. More in particular, an electro-motor can be stopped at an intermediate position, for example when the cutting device experiences a malfunction. In case of a servo-motor, the position of the motor can be accurately determined, thus providing feedback.

According to a second aspect, the invention provides a method for cutting paper with the use of the cutting device according to any one of the aforementioned embodiments, wherein the method comprises the steps of synchronously driving the spindles in a 1:1 ratio with the use of the mechanical synchronization element.

The method relates to the practical use of the previously discussed cutting device. Consequently, the method and its embodiments have the same technical advantages as the aforementioned cutting device and its respective embodiments. These advantages will not be repeated hereafter.

In another particular embodiment the driving direction is perpendicular to the cutting line.

Additionally or alternatively, the cutting blade comprises a flat or substantially flat cutting surface, wherein the driving direction is parallel or substantially parallel to said flat cutting surface.

In an embodiment thereof the cutting blade comprises an upper cutting edge that is angled at an oblique angle to the cutting line.

In an alternative embodiment the driving direction is arranged at an oblique angle to the cutting line. Preferably, the angle is in the range of thirty to eighty degrees and preferably in a range of forty to sixty degrees.

In a further embodiment thereof the cutting blade comprises an upper cutting edge that is parallel or substantially parallel to the cutting line.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows an isometric view of a cutting device for cutting paper according to a first embodiment of the invention;

FIG. 2 shows a front view of the cutting device according to FIG. 1;

FIG. 3 shows a cross section view of the cutting device according to line III-III in FIG. 1;

FIG. 4 shows a view from below of the cutting device according to FIG. 1;

FIG. 5A-5D shows a cross section views of the cutting device according to line V-V in FIG. 2;

FIG. 6 shows a cross section view of the cutting device according to line VI-VI in FIG. 2;

FIG. 7 shows a view from below of an alternative cutting device for cutting paper according to a second embodiment of the invention;

FIG. 8 shows a front view of a further alternative cutting device for cutting paper according to a third embodiment of the invention;

FIG. 9 shows a cross section view of the alternative cutting device according to the line IX-IX in FIG. 8; and

FIG. 10 shows a cross section view of a further alternative cutting device according to a fourth embodiment of the invention.

### DETAILED DESCRIPTION OF THE INVENTION

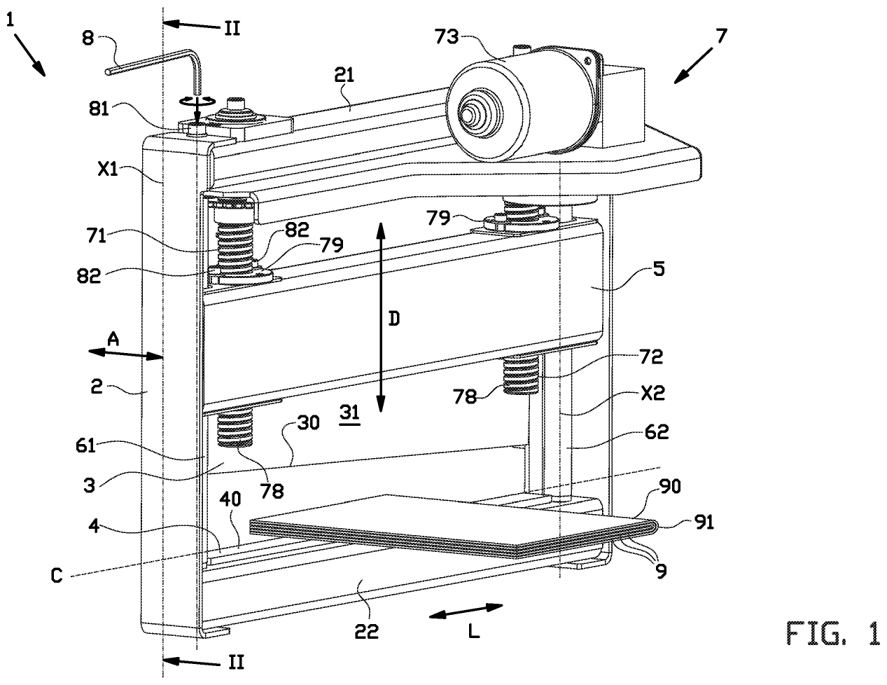

FIGS. 1-6 show a cutting device 1 according to a first exemplary embodiment of the invention. The cutting device 1 is arranged for shearing, trimming or cutting paper 9, in particular stacks of paper or booklets 90, for example in a document finishing line for the digital printing market. A document finishing line may comprise one or more of the cutting devices 1, i.e. to enable one-side, two-side or three-side trimming.

As shown in FIG. 1, the cutting device 1 comprises a housing or a frame 2 and a knife or a cutting blade 3 that is movably supported with respect to said frame 2 for cutting along a cutting line C. The cutting device 1 further comprises a counter-member in the form of a counter-knife or counter-blade 4 that is arranged in a stationary position at or along the cutting line C to cooperate with the movable cutting blade 3 to cut the paper 9. In this exemplary embodiment, the counter-knife 4 is mounted to the frame 2.

The cutting device 1 according to the first exemplary embodiment of the invention operates as a guillotine cutter. As such, the cutting blade 3 is movable in a driving direction D perpendicular to the cutting line C towards and away from the counter-blade 4 for cutting the paper 9. In this exemplary embodiment, the driving direction D is vertical or substantially vertical. Hence, the cutting blade 3 is movable in a vertically downward cutting stroke and a vertically upward return stroke. The cutting blade 3 is angled at an oblique angle to the cutting line C to progressively cut the paper 9 along the cutting line C. In contrast, the counter-blade 4 extends parallel or substantially parallel to the cutting line C.

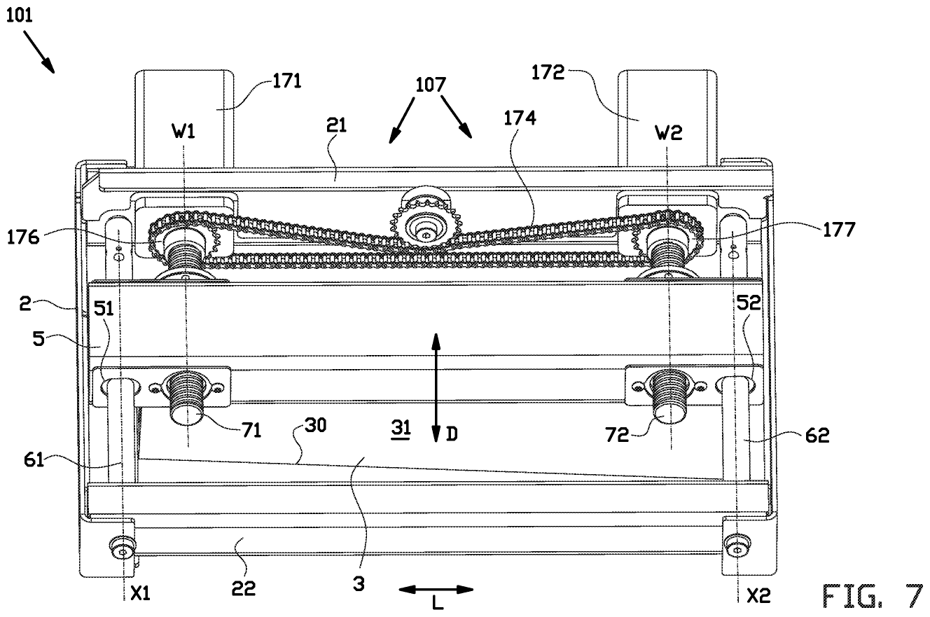

As best seen in FIG. 6, the cutting blade 3 comprises a flat or substantially flat cutting surface 31 that faces the counter-blade 4 when the cutting blade 3 moves across the cutting line C. The driving direction D is preferably parallel or substantially parallel to said flat cutting surface 31. The cutting blade 3 further has a front surface 32 that tapers towards the cutting surface 31 to form an upper cutting edge 30. Said upper cutting edge 30 is angled at an oblique angle to the cutting line C. As such, the upper cutting edge 30 has a lowest point that is closest to the counter-blade 4 in the driving direction D and a highest point that is further away from the counter-blade 4 in the driving direction D. In this exemplary embodiment, the front surface 32 is beveled to form a sharp chisel grind 33 together with the flat cutting surface 31. It will be apparent to one skilled in the art that other blade configurations are also possible and that the scope of the present invention is not limited to the configuration as shown.

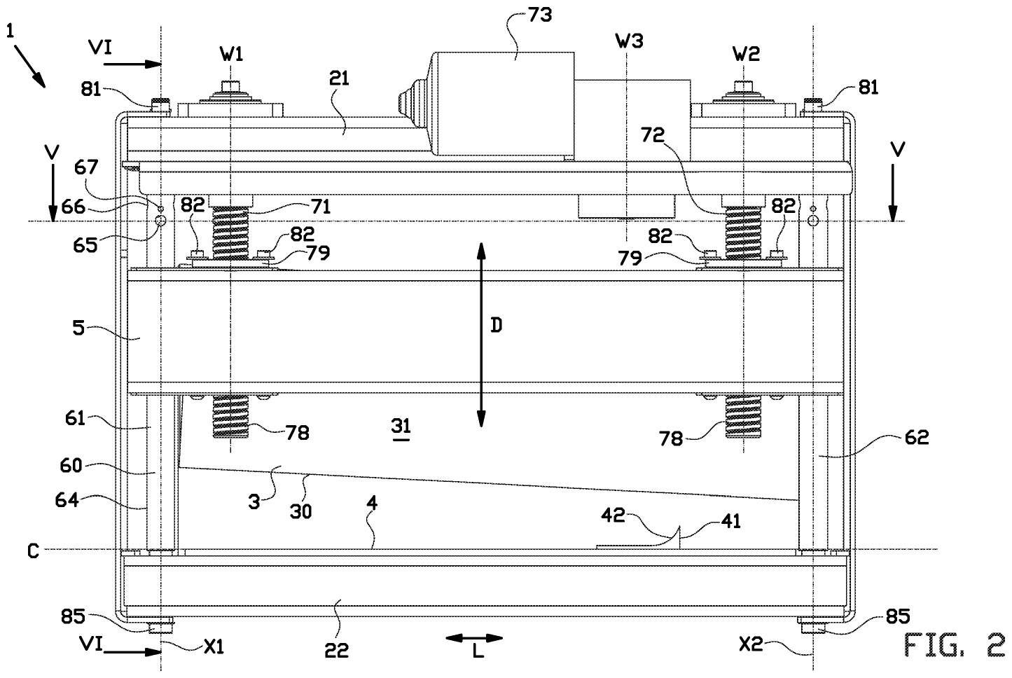

In this exemplary embodiment, the counter-blade 4 is formed as a rectangular strip that is secured to the frame 2 by bolts or other suitable fasteners at or along the cutting line C in a position opposite to the cutting blade 3. The counter-blade 4 forms a lower cutting edge 40 that extends parallel or substantially parallel to the cutting line C. The counter-blade 4 may be slightly beveled at the cutting edge 40. Optionally, as shown in FIG. 2, the counter-blade 4 may be provided with a support member 41 for supporting the spine 91 of a booklet 90, as schematically shown in FIG. 2. The support member 41 may be an integral part of the counter-blade 4 or may be mounted on the counter blade 4 with suitable fasteners. The support member 41 has a concave support surface 42 that is arranged to closely match and/or support the curvature of the spine 91 in place and thereby improve the cutting quality at said spine 91. In particular, paper snippets may be prevented at the spine 91.

As further shown in FIG. 6, the cutting device 1 comprises a holder 5 for holding the cutting blade 3 relative to the counter-blade 4. In this example, the cutting blade 3 is securely attached to the holder 5 by means of bolts or other suitable fasteners. Preferably, the rear of the surface 31 of the cutting blade 3 is arranged in direct abutment with the holder 5, i.e. without spacing, adjustment or calibration means, to reduce and/or eliminate tolerances between the cutting blade 3 and the holder 5.

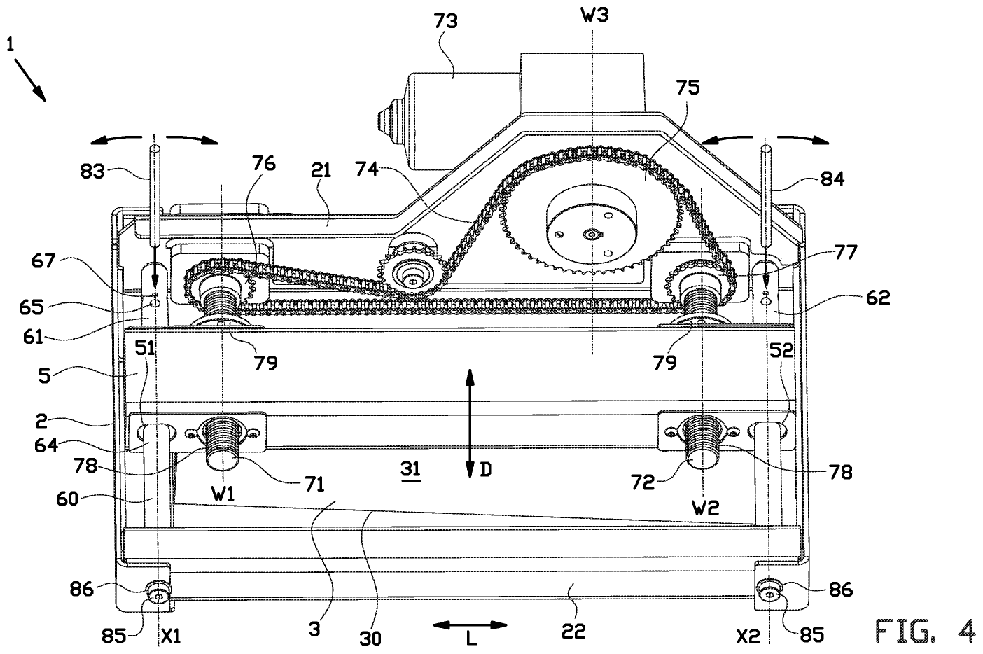

As best seen in FIG. 4, the cutting device 1 is provided with one or more guides 61, 62 extending in the driving direction D for linearly guiding the holder 5, with the cutting blade 3 attached thereto, in said driving direction D. In this example, the cutting device 1 comprises a first guide 61 and a second guide 62 which are spaced apart from each other, preferably at opposite ends of the holder 5.

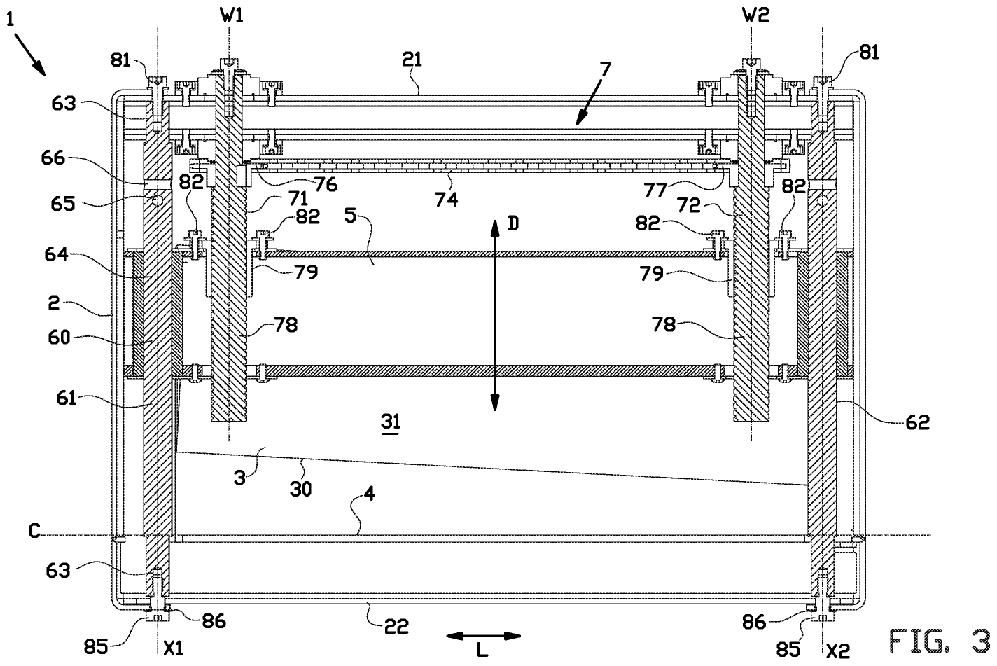

In a preferred embodiment of the invention, the one or more guides 61, 62 double as calibration members for calibrating the position of the cutting blade 3 relative to the counter-blade 4. In particular, as shown in FIG. 3, each guide 61, 62 comprises a guide body 60 that extends in the driving direction D between opposite parts of the frame 2, in this example being the upper end 21 and a lower end 22 of the frame 2, respectively. The holder 5 is arranged to be freely slide over or along said guide body 60 in the driving direction D. The cutting device 1 comprises one or more first fixation members 81 for fixating the guide bodies 60 of the first guide 61 and the second guide 62 relative to the frame 2. The one or more first fixation members 81 may be bolts, clamps or other suitable fasteners. The one or more first fixation members 81 are arranged for releasing the fixation of the guide bodies 60 relative to the frame 2, i.e. by loosening or unclamping. In this example, the one or more first fixation members 81 are bolts with a hexagonal socket that can be loosened and tightened with the use of a hex key 8, as shown in FIG. 1. When released, the guide body 60 is movable relative to the frame 2 in an adjustment direction A perpendicular to the cutting line C and the driving direction D, thereby displacing the holder 5 and the cutting blade 3 attached thereto relative to the counter-blade 4.

In the exemplary embodiment as shown in FIG. 6, the guide bodies 60 of the first guide 61 and the second guide 62, when released, are arranged to be rotatable relative to the frame 2 about a first adjustment axis X1 and a second adjustment axis X2, respectively. In particular, each guide body 60 comprises one or more concentric sections 63 that connect the guide body 60 concentrically about the respective adjustment axis X1, X2 to the frame 2. In this example, the concentric sections 63 are located at the top and the bottom of the guide body 60 at or near the upper end 21 and the lower end 22 of the frame 2. The guide body 60 is provided with concentrically located, threaded bores at the respective concentric sections 63 for threaded connection to one of the bolt-shaped first fixation members 81. Hence, said one first fixation member 81 concentrically connects to the guide body 60 and/or defines the adjustment axis X1, X2 of the respective guide 61, 62. Preferably, the frame 2 comprises one or more bearing surfaces to concentrically receive the concentric sections 63 and to ensure reliable rotation of said concentric sections 63 about the respective adjustment axis X1, X2 relative to the frame 2.

Each guide body 60 further comprises an eccentric section 64 that is eccentric with respect to the one or more concentric sections 63 and/or the respective adjustment axis X1, X2. As such, each eccentric section 64 is arranged to travel an eccentric path or moves eccentrically about the respective adjustment axis X1, X2 with at least a component in the adjustment direction A. The radii of the eccentric section 64 with respect to the respective adjustment axis X1, X2 vary within a maximum adjustment range R of at least half a millimeter, preferably at least one millimeters and most preferably at least two millimeters. Hence, each eccentric section 64 can effectively cause a displacement in the adjustment direction A within the specified range.

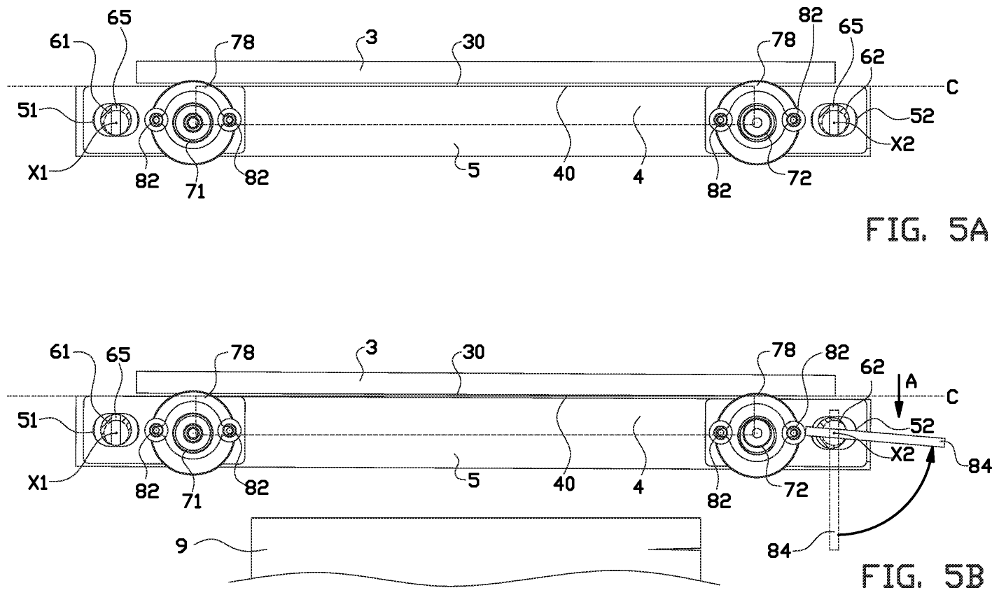

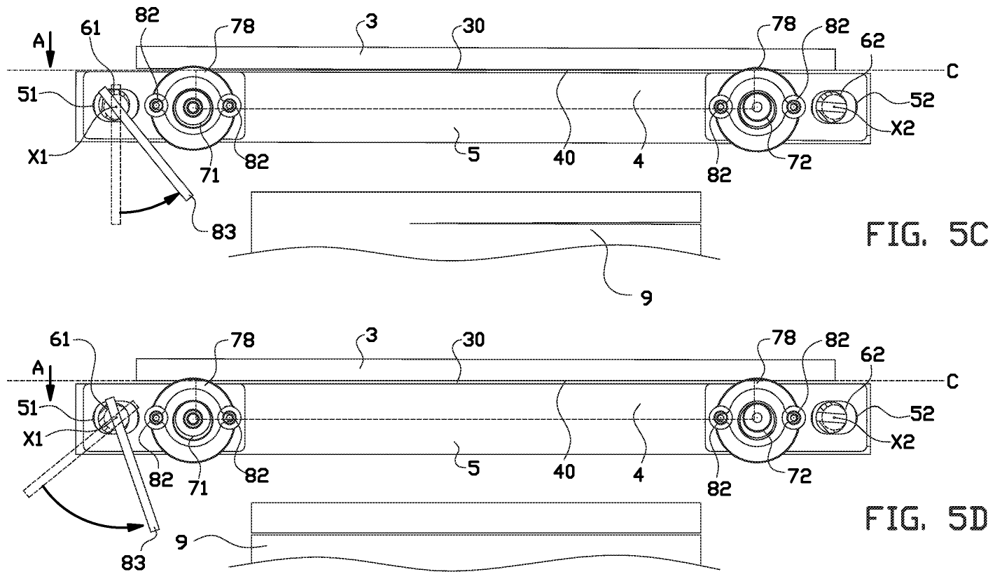

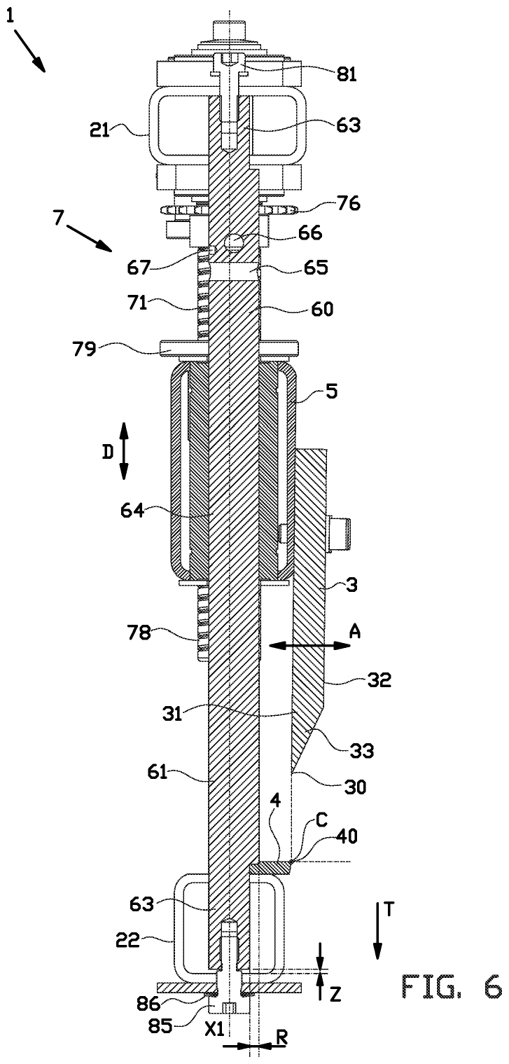

As best seen in FIGS. 5A-5D, the holder 5 is provided with slotted holes 51, 52 through which the eccentric sections 64 of the respective guides 61, 62 are received. The slotted holes 51, 52 are elongated in a lateral direction L perpendicular to the driving direction D and the adjustment direction A to absorb the eccentric movement of the eccentric sections 64 relative to the holder 5 in the lateral direction L and to closely follow the component of the eccentric movement of the eccentric sections 64 in the adjustment direction A. Consequently, the holder 5 moves with the eccentric movement of the eccentric sections 64 in the adjustment direction A only. In other words, the interaction between the slotted holes 51, 52 and the eccentric sections 64 effectively converts the rotational movement of the guides 61, 62 about the respective adjustment axes X1, X2 into a linear movement of the holder 5 in the adjustment direction A.

In this example, as best seen in FIGS. 3 and 4, each guide 61, 62 is provided with one or more tool engagement elements 65, 66 to facilitate engagement of the guide 61, 62 with a tool for rotating the guides 61, 62 about the respective adjustment axes X1, X2 with the use of (manual) tools. In particular, in this example, the one or more tool engagement elements 65, 66 are tool holes 65, 66 for receiving a pin or a lever 83, 84 that facilitates manual rotation of the guides 61, 62. Preferably, each guide 61, 62 comprises two or more tool engagement elements 65, 66 which are offset in a circumferential direction about the guide body 60 to receive or engage the same tool, i.e. the lever 83, 84, in different angular positions around the respective adjustment axis X1, X2. Hence, the lever 83, 84 may be inserted into one of the tool holes 65, 66 even if the other tool hole 65, 66 is rotated out of reach. Alternatively, the guides 61, 62 may be adjusted mechanically by adjustment drives (not shown). The adjustment may even be automated with the use of one or more sensors (not shown) that detect the relative position of the cutting blade 3 with respect to the counter blade 4 as a result of the adjustment.

Optionally, each guide 61, 62 may comprise a reference element 67, i.e. a marking, a recess or a protrusion, that indicates a special position of the respective guide 61, 62. Such a special position may be the position in which the guides 61, 62 position the cutting blade 3 at a distance in which the upper cutting edge 30 and the lower cutting edge 40 are maximally spaced apart from the counter-blade 4 in the adjustment direction A. Note that the maximum spacing between the cutting blade 3 and the counter-blade 4 does not necessarily correspond to the maximum adjustment range R of the guides 61, 62 in the adjustment direction A. Instead, it is preferred to have the cutting blade 3 closer to the counter-blade 4 than said maximum adjustment range R at said maximum spacing, such that the position of the cutting blade 3 can be calibrated relative to the counter-blade 4 within the maximum adjustment range R that overlaps with the counter-blade 4. Consequently, when the cutting blade 3 and/or the counter-blade wear down, part of the maximum adjustment range R remains unused to compensate accordingly. In this example, the upper cutting edge 30 is spaced apart maximally from the lower cutting edge 40 in the adjustment direction A at a distance of approximately half a millimeter. Hence, with a maximum adjustment range R of for example one millimeter, the position of the cutting blade 3 can be adjusted over half a millimeter beyond the counter-blade 4 within the maximum adjustment range R.

As shown in FIGS. 2, 3, 4 and 6, the guides 61, 62 are fixed to the lower end 22 of the frame 2, by suitable fasteners 85, preferably bolts. In this exemplary embodiment, the fasteners 85 fixated against rotation relative to the frame 2 about the respective adjustment axis X1, X2 by a suitable spring 86, e.g. a cupped spring or a disc spring. In particular, the spring 86 tensions the fastener 85 relative to the frame 2 in a tension direction T, parallel to the driving direction D. As shown in FIG. 6, a small clearance Z is provided between the guide body 60 and the lower end 22 of the frame 2 in the driving direction D to allow the respective guide body 60 to be moved relative to the frame 2 in the tension direction T when the one or more first fixation members 81 at the top end 21 of the frame 2 release the fixation of the guide bodies 60 relative to the frame 2. This reduces the tension on the springs 86, which allows the guide bodies 60 to rotate about the respective adjustment axes X1, X2 without the need to manually interact with the fasteners 85 at the lower end 22 of the frame 2.

As shown in FIGS. 3 and 4, the cutting device 1 is provided with a drive mechanism 7 to drive the movement of the cutting blade 3 in the driving direction D towards and away from the counter-blade 4. The drive mechanism 7 comprises a first spindle 71 and a second spindle 72 extending in or parallel to the driving direction D. The first spindle 71 and the second spindle 72 are arranged for acting in or parallel to the driving direction D on the holder 5 and/or the cutting blade 3. The drive mechanism 7 is further provided with a motor 73 and a transmission element 74 that connects the motor 73 to the first spindle 71 and the second actuator 72. By using a single motor 73 common to or shared by both spindles 71, 72, said spindles 71, 72 can be mechanically synchronized. In particular, the transmission element 74 can be mechanical, i.e. a chain or a toothed belt, to connect the motor 73 to each of the spindles 71, 72 in a fixed ratio which is the same for both spindles 71, 72. More in particular, the transmission element 74 is arranged to interconnect the first spindle 71 and the second spindle 72 in a 1:1 ratio. Hence, the transmission element 74 acts as a synchronization element. Preferably, the drive mechanism 7 comprises a main sprocket wheel 75 that is directly connected to the motor 73 and that drives the chain or belt-like transmission element 74. The drive mechanism 7 further comprises a plurality of idler wheels 76, 77 of the same size that output the rotation of the main sprocket wheel 75 to both spindles 71, 72 in an equal ratio.

As shown in FIGS. 2 and 4, the main sprocket wheel 75 and the idler wheels 76, 77 at the spindles 71, 72 are rotatable about wheel axes W1, W2, W3 parallel or substantially parallel to the driving direction D. Hence, the transmission of the rotation of the main sprocket wheel 75 to the idlers wheels 76, 77 can all occur in the same plane, perpendicular to said driving direction D.

Preferably, the main sprocket wheel 75 is connected to the idler wheels 76, 77 in a ratio of at least 2:1, preferably at least 2.5:1 and most preferably at least 3:1.

Preferably, the motor 73 is an electro-motor, in particular an electric servo-motor. Hence, the position of the motor 73 can be very accurately determined and/or controlled.

Each spindle 71, 72 comprises a screw 78 that is arranged to be rotated by the transmission element 74 and a nut 79 that travels linearly along the screw 78 as the screw 78 rotates. The screws 78 of the spindles 71, 72 extend parallel to the guides 61, 62 in the driving direction D.

As shown in FIGS. 2-4, the holder 5 is fixed to the linearly moving parts of the spindles 71, 72, in this example to the nuts 78, with the use of one or more second fixation members 82. The one or more second fixation members 82 may be bolts, clamps or other suitable fasteners. The one or more second fixation members 82 are arranged for releasing the fixation of the holder 5 relative to the nuts 78, i.e. by loosening or unclamping. In this example, the one or more second fixation members 82 are bolts with a hexagonal socket that can be loosened and tightened with the use of the same hex key 8 that is used to loosen and tighten the one or more first fixation members 81 at the guides 61, 62. When released, the holder 5 is movable relative to the nuts 79 in the adjustment direction A to facilitate the aforementioned adjustment of the guides 61, 62 in said adjustment direction A. In particular, it can be observed in FIGS. 5A-5D that the holder 5 is movable with respect to the spindles 71, 72 in the adjustment direction A within the maximum adjustment range R, as shown in FIG. 6.

A method for cutting paper with the use of the aforementioned cutting device 1 will now be explained with reference to FIGS. 1-6.

When cutting paper, it is important to calibrate the position of the cutting blade 3 with respect to the counter-blade 4. When the cutting blade 3 is too far spaced apart from the counter-blade 4, the paper will not be cut. When the cutting blade 3 is too close to the counter-blade 4, the cutting device 1 may become jammed. Moreover, the cutting blade 3 and the counter-blade 4 preferably are not at a constant distance along the cutting line C. In other words, their upper cutting edge 30 and lower cutting edge 40 should not be parallel. Ideally, the cutting blade 3 is calibrated so that the lowest point of its upper cutting edge 30 is as close as possible to the lower cutting edge 40 of the counter-blade 4, without making contact. In contrast, the highest point of the upper cutting edge 30 should slightly overlap with the lower cutting edge 40 to create a small tension or bias between the cutting blade 3 and the counter-blade 4 during the cutting.

In the prior art cutting devices, calibration required specialized knowledge and above all; time. Calibration took at least half an hour or more, depending on the experience of the calibration technician. With the cutting device 1 according to the present invention, the calibration can be performed within a few minutes.

As shown in FIG. 1, the one or more first fixation members 81 are loosened, i.e. by untightening the bolts with the hex key 8, to release the fixation of guides 61, 62 relative to the frame 2. Additionally, the one or more second fixation members 82 are loosened, i.e. by untightening the bolts with the same or another hex key 8, to release the fixation of the drive mechanism 7, and in particular the nuts 79 thereof, with respect to the holder 5. The holder 5 is now no longer fixated with respect to the guides 61, 62 and the drive mechanism 5. Consequently, the respective positions of the guides 61, 62 can be adjusted and the holder 5, with the cutting blade 3 attached thereto, can freely follow the movement of the guides 61, 62 during said adjustment.

As shown in FIG. 4, a tool is coupled to, insertable in and/or arranged to engage one of the one or more tool engagement elements 65, 66 at one of the guides 61, 62 to adjust the position of said one guide 61, 62. In this example, a first lever 83 is inserted into one of the tool holes 65, 66 at the first guide 61. The same first lever 83 may also be used to engage the one of the tool holes 65, 66 at the second guide 62. Instead, a second lever 84 may be used to adjust the positions of the guides 61, 62 simultaneously. Preferably, the guides 61, 62 are initially moved into a special position, i.e. the position marked by the reference element 67. In said special position the cutting blade 3 is at a distance maximally spaced apart from the counter-blade 4 in the adjustment direction A. Alternatively, the calibration may be initiated from any position, i.e. the current position of the cutting blade 3.

Now, the calibration may start in accordance with the steps as described below and as shown in FIGS. 5A-5D.

FIG. 5A shows the situation with the guides 61, 62 in a position in which the cutting blade 3 is maximally spaced apart from the counter-blade 4. FIG. 5B shows the situation in which the position of the lowest end of the upper cutting edge 30 is adjusted towards the lower cutting edge 40 by turning the second guide 62 clockwise or counter-clockwise about the second adjustment axis X2. Based on experience, the calibration technician may already know the amount of rotation required to approximate the optimal position of the second guide 62. Alternatively, small increments may be used. Between each increment, the calibration technician may perform a cutting stroke on a single sheet of paper 9 to check if said single sheet of paper 9 is already being cutting by the lowest end of the upper cutting edge 30. As soon as the upper cutting edge 30 starts to cut the paper 9 at the lowest end, as shown in FIG. 5B, the second guide 62 is in position and should no longer be adjusted. Preferably, the one or more first fixation members 81 associated with the second guide 62 may be tightened or fastened again with suitable tools to fix the position of the second guide 62 relative to the frame 2.

FIG. 5C shows the situation in which the calibration technician has started to adjust the position of the first guide 61. Again, based on experience, the calibration technician may already know the amount of rotation required to approximate the optimal position of the first guide 61. Alternatively, small increments may be used. Between each increment, the calibration technician may perform a cutting stroke to check if the paper 9 is already being cutting by the highest end of the upper cutting edge 30. With each increment, the cut in the paper 9 will progressively increase in length until the upper cutting edge 30 cuts along the cutting line C across the entire width of the paper 9. FIG. 5C shows the situation in which the paper 9 is only cut half-way across the width. FIG. 5D shows the situation in which the paper 9 is cut completely, which is an indicator that the first guide 61 is now properly positioned and/or that the upper cutting edge 30 is properly calibrated with respect to the lower cutting edge 40. When the first guide 61 is properly positioned, the one or more first fixation members 81 associated with the first guide 61 may be tightened or fastened again with suitable tools to fix the position of the first guide 61 relative to the frame 2.

Optionally, the calibration technician may perform an additional check in which a stack of paper 90, as for example shown in FIG. 1, is cut. The stack of paper 90 may cause some deburring at the cutting edges 30, 40 that may have a negative impact on the cutting quality. After the stack of paper 90 has been cut successfully, the calibration technician again cuts a single sheet of paper 9 to see if said single sheet of paper 9 is still cut consistently. If not, the abovementioned calibration steps are repeated.

Finally, the one or more second fixation members 82 are tightened or fastened with suitable tools to fixate the position of the drive mechanism 7 with respect to the holder 5 in its newly calibrated position. The cutting device 1 according to the invention is now calibrated and ready for cutting.

When cutting through a stack of paper 90, as shown in FIG. 1, the cutting blade 3 is subjected to a load travelling along its obliquely angled upper cutting edge 30. This causes uneven loads on the spindles 71, 72. However, the transmission element 74 as shown in FIG. 4 ensures that both spindles 71, 72 are driven at the same speed, thereby synchronizing their operation. Hence, skewing, misalignment and/or tension between the cutting blade 3, the spindles 71, 72 and/or the guides 61, 62 can be reduced or even prevented.

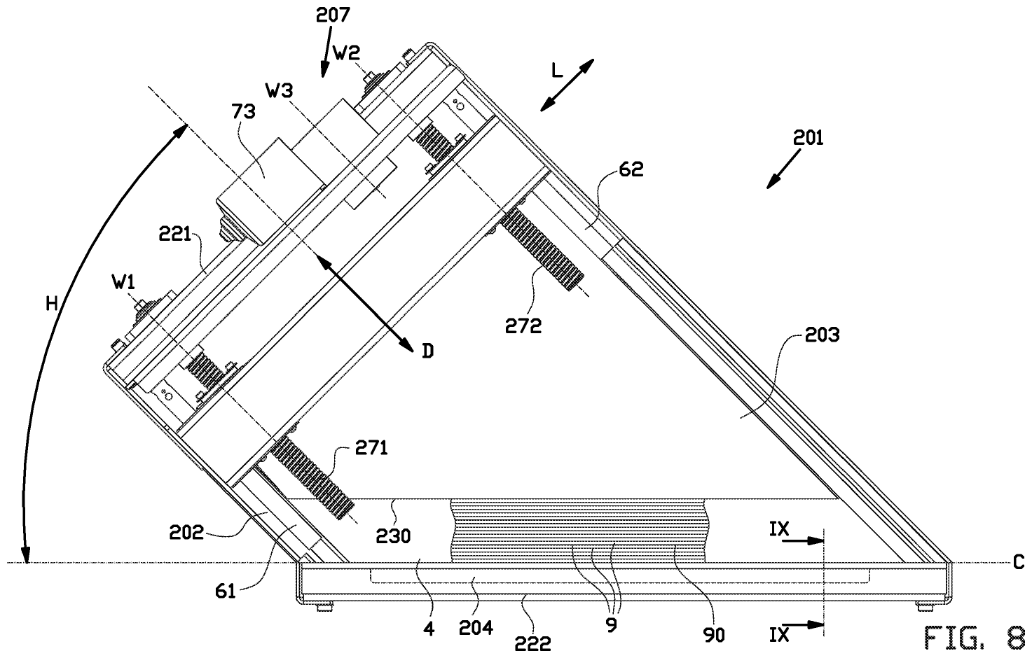

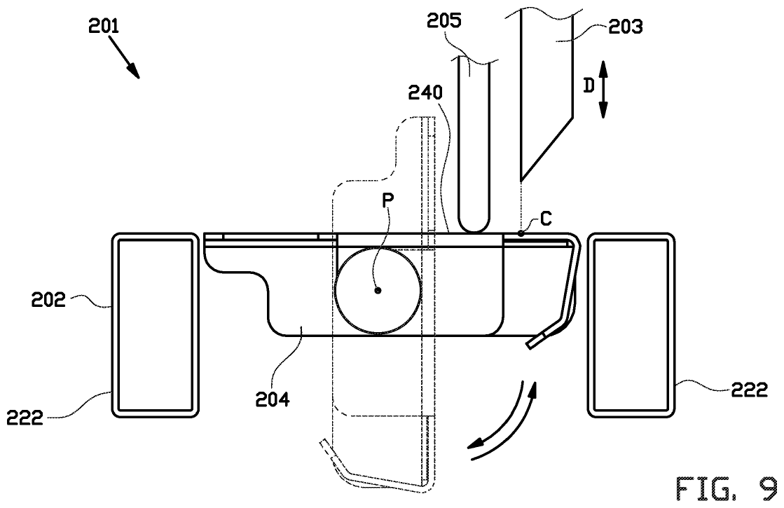

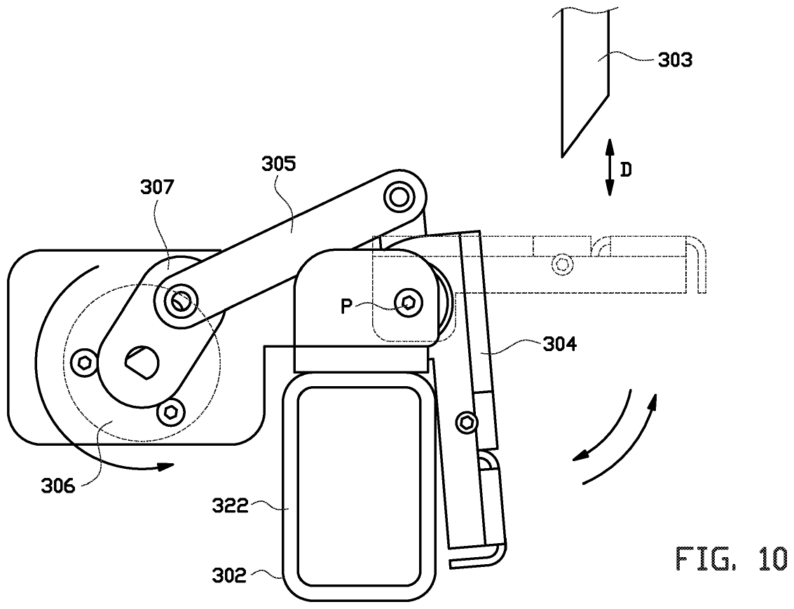

FIG. 7 shows an alternative cutting device 101 according to a second exemplary embodiment of the invention. The alternative cutting device 101 differs from the previously discussed cutting device 1 in that it features an alternative drive mechanism 107 with a first motor 171 and a second motor 172 for driving the movement of the first spindle 71 and the second spindle 72, respectively, in the driving direction D. Consequently, each spindle 71, 72 has its own motor 171, 172. The spindles 71, 72 may therefore be driven directly. The alternative drive mechanism 107 further comprises a mechanical synchronization element 174 to synchronize the spindles 71, 72. In particular, the mechanical synchronization element 174 is arranged to interconnect the first spindle 71 and the second spindle 72 in a 1:1 ratio. In this example, the synchronization element 174 is a chain or a toothed belt. The chain or toothed belt engages with idler wheels 176, 177 at the respective spindles 71 72 and interconnects said idler wheels 176, 177 in a 1:1 ratio. In this manner, the synchronization element 174 can prevent that one of the spindles 71, 72 rotates faster than the other, i.e. as a result of uneven loads on the cutting blade 3.

FIG. 8 shows a further alternative cutting device 201 according to a third exemplary embodiment of the invention. The further alternative cutting device 201 differs from the previously discussed cutting device 1, 101 in that its driving direction D extends obliquely or transverse to the cutting line C. In particular, the alternative driving direction D as shown in FIG. 8 is at an angle H in a range of thirty to eighty degrees with respect to the cutting line C, more preferably in a range of forty to sixty degrees and most preferably at an angle H of approximately forty-five degrees.

The further alternative cutting device 201 further differs from the previously discussed cutting devices 1, 101 in that it features an alternative cutting blade 203 and counter-member 204 configuration. While the counter-member 204 is still supported in a substantially level or horizontal orientation and supports the paper 9 along a substantially level or horizontal cutting line C, the alternative cutting blade 203 moves at the oblique driving direction D towards the counter-member 204 and has an upper cutting edge 230 that extends parallel or substantially parallel to the cutting line C.

As a result of the oblique driving direction D, the alternative cutting blade 203 travels towards the cutting line C with a component in the vertical direction and a component in the horizontal direction, parallel to the cutting line C. The upper cutting edge 230 thus makes a sawing movement through the stack of paper 90 rather than a vertical guillotine cutting movement. This allows the alternative cutting blade 203 to saw through thicker stacks of paper 90.

To accommodate the alternative cutting blade 203 moving at the oblique driving direction D, an alternative frame 202 is provided with an upper end 221 that is angled to match the oblique driving direction D and a lower end 222 that supports the counter-member 204 at the cutting line C. The further alternative cutting device 201 is provided with an alternative drive mechanism 207 that has spindles 271, 272 arranged at the same angle H to the cutting line C as the oblique driving direction D. In other words, the spindles 271, 272 are arranged to act in or parallel to the oblique driving direction D. Apart from the orientation, the alternative drive mechanism 207 may function similarly to the drive mechanisms 7, 107 of the previous embodiments of the invention.

Note that one side of the frame 202 is now considerably longer than the other side. The guides 61, 62 may remain the same length as in the previous embodiments of the invention, as they only need to provide guidance at the location of the holder 5. Optionally, the length of the spindles 271, 272 may be increased to increase the length of the cutting stroke. The length of the guides 61, 62 may be increased accordingly. Hence, the thickness of the stacks of paper 90 that can be cut is in principle only limited by the geometrical limitations of the available space.

The combination of the oblique driving direction D and the spindles 271, 272 acting in or parallel to said oblique driving direction D results in a sawing action during which the load on the alternative cutting blade 230 remains substantially constant at any depth during the cutting, regardless of the thickness of the stack of paper 90 that is being cut. Hence, the maximum thickness of stacks of paper that can be cut is in principle limitless.

In this alternative embodiment, the counter-member 204 forms a flat counter-surface 240 at the cutting line C that cooperates with the alternative cutting blade 203 to cut the paper 9. The cutting process may leave snippets of paper 9 or other paper residue on the counter-surface 240. In conventional cutting devices, these paper snippets have to be removed manually. In the present invention, the counter-member 204 is pivotable relative to the lower end 222 of the frame 202 about a pivot axis P to drop the paper snippets from the counter-surface 240, i.e. into a waste bin below the cutting device 201. The pivoting may be user-activated or automatically activated after a predetermined number of cuts. The automatic activation may be performed by a pushing member 205, i.e. a mechanical finger, that pushes down on the counter surface 240 at the same side of the pivot axis P as the cutting line C to force the counter-member 204 into a drop position.

Alternatively, as shown in a further alternative cutting device according to a fourth embodiment of the invention, the counter-member 304 may be driven in rotation about the pivot axis P by a drive 306, i.e. a servo-motor. Also in this case, the counter-member 304 is pivotable relative to the lower end 322 of the frame 302 about a pivot axis P to move into an active position (shown in dashed lines) and a drop position (shown in solid lines) relative to the cutting blade 303. In this particular example, the transmission from the drive 306 to the counter-member 304 is an eccentric drive comprising a crank shaft 307 that is driven in rotation by the drive 306 and an arm or a finger 305 driven by said crank shaft 307. The finger 305 is connected to the counter-member 304 at a distance from the pivot axis P so that it may act as a lever on the counter-member 304.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-24. (canceled)

25. A cutting device for cutting paper, wherein the cutting device comprises a cutting blade and a counter-member that cooperate to cut the paper along a cutting line,
wherein the cutting blade is movable towards and away from the counter-member in a driving direction, transverse or perpendicular to the cutting line, for cutting the paper,
wherein the cutting device is provided with a drive mechanism to drive the movement of the cutting blade with respect to the counter-member in the driving direction,
wherein the drive mechanism comprises a first spindle and a second spindle which are arranged to act on the cutting blade in or parallel to the driving direction,
wherein the drive mechanism further comprises one or more motors for driving the first spindle and the second spindle and a mechanical synchronization element in the form of a chain or a toothed belt that is arranged to synchronize the first spindle and the second spindle in a 1:1 ratio,
wherein the drive mechanism comprises an idler wheel at each of the spindles,
wherein the synchronization element interconnects the idler wheel at the first spindle with the idler wheel at the second spindle in a 1:1 ratio.

26. The cutting device according to claim 25, wherein the one or more motors comprises a single motor that drives the movement of both the first spindle and the second spindle in the driving direction.

27. The cutting device according to claim 26, wherein the drive mechanism comprises a main sprocket wheel that is directly connected to the single motor and that drives the synchronization element,
wherein the synchronization element connects the main sprocket wheel to the idler wheel at the first spindle and the idler wheel at the second spindle.

28. The cutting device according to claim 27, wherein the main sprocket wheel and the idler wheels at the spindles are rotatable about wheel axes parallel to the driving direction.

29. The cutting device according to claim 27, wherein main sprocket wheel is connected to the idler wheels in a ratio of at least 2:1.

30. The cutting device according to claim 25, wherein the one or more motors comprises a first motor and a second motor for driving the movement of the first spindle and the second spindle, respectively, in the driving direction.

31. The cutting device according to claim 30, wherein the first motor and the second motor are arranged for directly driving the first spindle and the second spindle, respectively.

32. The cutting device according to claim 25, wherein the driving direction is perpendicular to the cutting line.

33. The cutting device according to claim 25, wherein the cutting blade comprises a flat cutting surface,
wherein the driving direction is parallel to said flat cutting surface.

34. The cutting device according to claim 32, wherein the cutting blade comprises an upper cutting edge that is angled at an oblique angle to the cutting line.

35. The cutting device according to claim 25, wherein the driving direction is arranged at an oblique angle to the cutting line.

36. The cutting device according to claim 35, wherein the angle is in the range of thirty to eighty degrees.

37. The cutting device according to claim 35, wherein the cutting blade comprises an upper cutting edge that is parallel to the cutting line.

38. The cutting device according to claim 25, wherein the one or more motors comprises one or more electro-motors.

39. A method for cutting paper with the use of the cutting device according to claim 25, wherein the method comprises the steps of synchronously driving the spindles in a 1:1 ratio with the use of the mechanical synchronization element.

40. The method according to claim 39, wherein the driving direction is perpendicular to the cutting line.

41. The method according to claim 40, wherein the cutting blade comprises a flat cutting surface,
wherein the driving direction is parallel to said flat cutting surface.

42. The method according to claim 40, wherein the cutting blade comprises an upper cutting edge that is angled at an oblique angle to the cutting line.

43. The method according to claim 39, wherein the driving direction is arranged at an oblique angle to the cutting line.

44. The method according to claim 43, wherein the angle is in the range of thirty to eighty degrees.

45. The method according to claim 43, wherein the cutting blade comprises an upper cutting edge that is parallel to the cutting line.
